(19) United States
(12) Patent Application Publication
(10) Pub. No.: US 2013/0256406 A1
(43) Pub. Date: Oct. 3, 2013

(54) METHOD OF MEASURING LENGTH USING NEW BARCODE SYMBOLOGY

(71) Applicant: Ravi Kumar Nallapa Reddy, Madanapalli (IN)

(72) Inventor: Ravi Kumar Nallapa Reddy, Madanapalli (IN)

(21) Appl. No.: 13/992,833

(22) PCT Filed: Dec. 12, 2011
(86) PCT No.: PCT/IN2011/000848

§ 371 Date: Jun. 10, 2013

(30) Foreign Application Priority Data
Dec. 15, 2010 (IN) 3831/CHE/2010

(51) Int. Cl. G06K 19/06; G06K 7/10; G06K 7/14

(52) U.S. Cl. CPC G06K 19/06028; G06K 7/1413; G06K 7/10821
USPC 235/375; 235/494; 235/462.25

(57) ABSTRACT

The system proposes software barcode mechanism and Hardware barcode mechanism to read new barcode symbology. In the software barcode based system, a scanner is used to scan the barcode. The barcode information is further sent to a decoding unit. The decoding unit extracts data from the received undecoded data and converts them to corresponding scale unit. In a hardware based barcode system, a plurality of slider pins attached to a slider header slides over the hardware barcodes. The electric signals corresponding to value of barcode at each point is transmitted to a decoding unit. The decoding unit processes the received signals and converts the signals to corresponding scale unit. Further the scale unit refers to the length of the material or distance between materials.

### FIELD OF INVENTION

This invention relates to design of machine readable representation of encoded data using barcode symbologies.

### BACKGROUND OF INVENTION

Barcodes more commonly referred to as barcode labels are used to store information regarding various types of object i.e. from small sized material to large material. Barcodes are generally represented by parallel strips in black and white and the sequence of barcode is scanned by barcode scanners, which decode the information present in the barcode. Decoders in barcode scanner converts scanned data from the barcode into machine readable data characters.

There are different types of standards available to recognize these data characters. The standards are known as symbologies. Common symbologies used nowadays are UPC, Code39, Code93, Code128, EAN, Postal barcodes etc. The barcodes have been used to quickly identify and store information about products. These barcodes are extensively used in retail, warehouse, and distribution to keep track of numerous products.

Digital Scales are used to measure length of an object or distance between two objects. Different scales available in the market are Linear Digital Scale, Micrometer Scale, Weight Scales, and Pressure Scales etc. Meter, Centimeter, Millimeter, Inch, etc are commonly used parameters to measure lengths in linear digital scales. Advanced technology scales such as Laser or Ultrasonic scales are used for industrial purpose. These scales are expensive compare to other traditional scales. These scales measure length in terms of millimeters and there are very expensive scales which can measure in microns also.

Current digital scales have limitation on maximum measurable length. Digital scales which measures length in millimeter are not equipped to measure length in meters and vice versa. Also, digital measurement scales are sensitive in nature and are not convenient for rough use.

### OBJECT OF INVENTION

The principal object of this invention is to measure the length of an object using new barcode symbology, wherein the new barcode symbology can be software printed barcodes or hardware designed barcodes.

Another object of the invention is the design of decoder apparatus to read the new barcode symbology, wherein the new barcode symbology can be software printed barcodes or hardware designed barcodes.

Another object of the invention is the design of slider barcode reader to read the hardware designed barcode symbology.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### STATEMENT OF INVENTION

The embodiments herein achieve a method of measuring length using barcode symbology and design of its corresponding decoder apparatus to read the new barcode symbology. Referring now to the drawings, and more particularly to FIGS. 1 through 16, where similar reference characters denote corresponding features consistently throughout the figures, there are shown preferred embodiments.

### BRIEF DESCRIPTION OF FIGURES

This invention is illustrated in the accompanying drawings, throughout which like reference letters indicate corresponding parts in the various figures. The embodiments herein will be better understood from the following description with reference to the drawings, in which:

FIG. 1a and FIG. 1b depict examples of the new software printed barcode symbology, according to embodiments as disclosed herein;

FIG. 2a and FIG. 2b depict various elements defined in the software printed barcode symbology, according to embodiments as disclosed herein;

FIG. 3a, FIG. 3b represent relationship between barcode labels and Scale unit, according to embodiments as disclosed herein;

FIG. 4a and FIG. 4b shows how to read Software designed printed barcode, according to embodiments as disclosed herein;

FIG. 5a and FIG. 5b depict barcode formats contain 10 data lines and 9 data lines along with one sub data line respectively, according to embodiments as disclosed herein;

FIG. 6a and FIG. 6b depict simple barcode symbology format, according to embodiments as disclosed herein;

FIG. 7 is a flow diagram illustrating the procedure for decoding software printed barcode data into Scale unit, according to embodiments as disclosed herein;

FIG. 8a, FIG. 8b and FIG. 8c are examples of hardware designed barcodes, according to embodiments as disclosed herein;

FIG. 9a and FIG. 9b depict various elements defined in the hardware designed barcode symbology, according to embodiments as disclosed herein;

FIG. 10a, FIG. 10b and FIG. 10c represent relationship between barcode labels and Scale unit, according to embodiments as disclosed herein;

FIG. 11 depicts Slider Reader equipment to read hardware designed barcodes, according to embodiments as disclosed herein;

FIG. 12a, FIG. 12b and FIG. 12c are pictorial representation of the slider reader rolling on the barcode frame, according to embodiments as disclosed herein;

FIG. 13a is another Hardware Barcode design representation where the complete frame is thin sheet with wholes in whitespace region, according to embodiments as disclosed herein;

FIG. 13b is representation of thin sheet Hardware Barcode design moving freely inside the Slider Reader;

FIG. 14 depicts measuring liquid level of a tank by placing the hardware barcode frame in the liquid tank;

FIG. 15 is a flow chat illustrating the procedure for decoding barcode data into Scale unit, according to embodiments as disclosed herein; and

FIG. 16a and FIG. 16b illustrates block diagrams of the proposed software barcode reading system and hardware barcode reading system respectively, as disclosed in the embodiments herein.

### DETAILED DESCRIPTION OF INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein

All embodiments classified as—Software Printed Barcode Symbology, Hardware Designed Barcode Symbology, Slider Barcode Reader to read Hardware Designed Barcode Symbology and Decoding processes to decode Software & Hardware Designed Barcode Symbology.

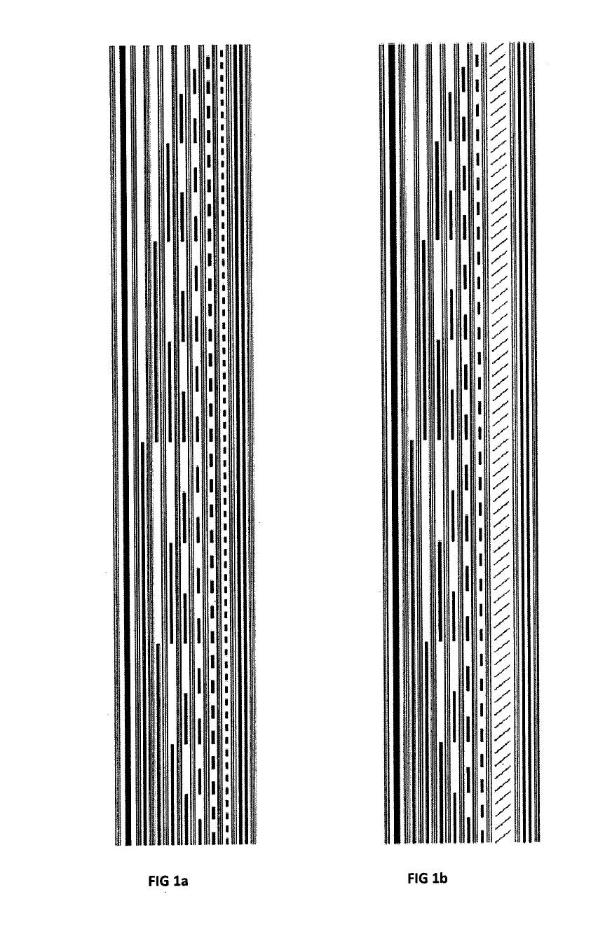

Software printed barcode symbology contains straight black lines, with some black lines interleaved with white spaces. FIG. 1a and FIG. 1b are examples of the new software printed barcode symbology. Software printed barcode symbology could be represented by various designs. e.g. FIG. 1b contains small cross lines in additions to the black lines represented in FIG. 1a format.

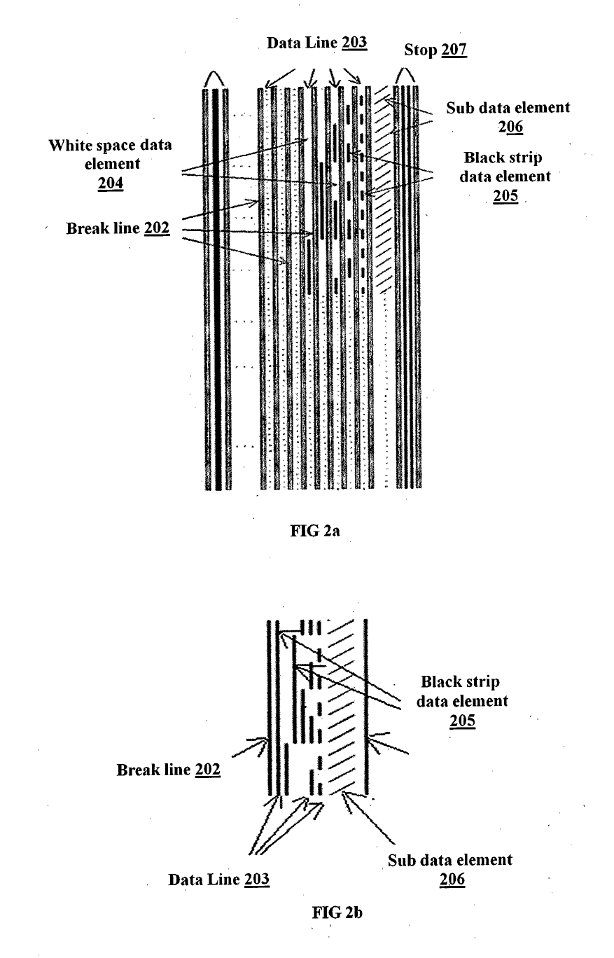

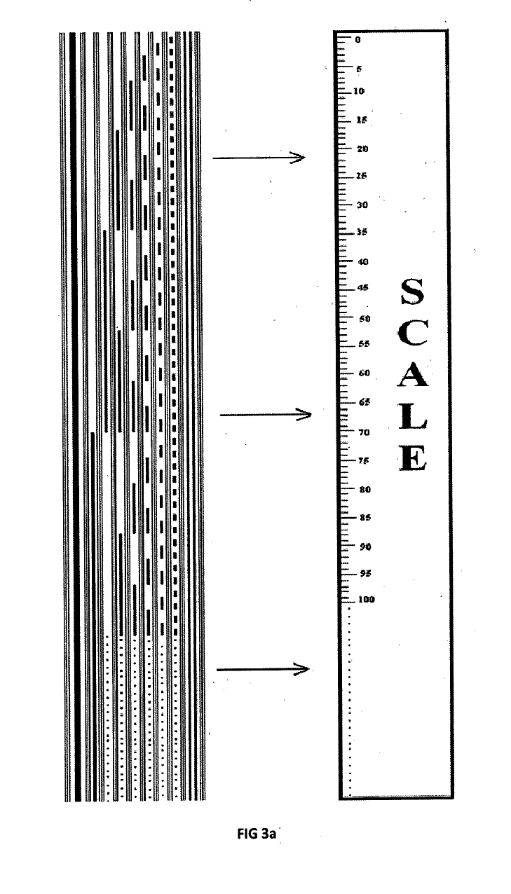

The structural representation of printed barcode symbology is shown in FIG. 2a and FIG. 2b. The barcode symbology shown in FIG. 2a & FIG. 2b comprises of the following elements:

Start Line 201—Start Line 201 is the starting check point to start collecting data.
Break Line 202—Break line 202 is used to identify data lines.
Data Line 203—Data Lines 203 are straight lines which comprises of sequence of Black lines and White spaces. All black lines and white spaces are in equal size in the straight line.
Data Element—Each black strip 205 or white space 204 is considered to be one data element in a Data line. Only one data element is countable in a data line to measure distance. Data elements are two types—White space data element 204 and Black Strip data element 205 where White space data elements 204 are considered to be Zero ‘0’ and Black Strip data element 205 is considered to be one ‘1’. All data elements are equal in size in a data line where as data elements are double in size in two subsequent data lines.
Subdata Element 206—Subdata element 206 is very important component in the mentioned embodiment to measure precious length of any object. Each subdata element 206 is associated with one data element of last Data line 203 in the barcode pattern.
Stop Line 207-Stop Line 207 is ending check point to stop collecting data.
START 201 and STOP 207 lines truncates lead and trail data while decoding. A START data line 201 is, a group of one black strip line with two white space lines, the black strip line is the same length as the white space lines. A STOP data line 207 is a group of three white space lines and two black strip lines with equal length. The format of STOP 207 and START 201 elements can also change which is recognized by barcode decoder. Both STOP 201 & START 207 data lines are any group of straight and white space lines which uniquely identifies both data lines.

The lines between two BREAK LINES 202 are considered to be one data line 203. After removing all check points, the actual data comprise of sequence of White Space elements 204 and Black strip elements 205 which will appear in binary format at any particular position. Each data line 203 is separated by a break line 202. A break line 202 comprises of three black bars and two white spaces. All these are in straight line and are in equal size. Printed barcode symbology can also be represented with only data lines 203 and sub data lines 206, as shown in FIG. 2B.

Each data line 203 is represented by binary sequence codes where white spaces represents zero and black strip represents one. And each data line 203 sequence is dependent on the previous data line 203. For example, consider a barcode symbology with five data lines 203. First data line 203 comprises of two elements one white space and black bar, both of equal size. The second data line comprises of four data elements of which two white spaces and two black bars, all four elements are of equal size. White spaces and black bars are arranged alternatively. The total number of data elements present in the second data line is equal to the double of total data elements present in first data line. Similarly, third data line comprises of 8 data elements and fourth data line comprises of 16 data elements. Each data line 203 is a binary sequence in the form of 010101010101 series. The following data lines represented in binary series.

### Data Line 1=0000000000000000011111111111111111

### Data Line 2=0000011110000111100000111100001111

### Data Line 3=0011001100110011000110011001100110

### Data Line 4=0101010101010101010101010101010100

Continues sequence of zero's OR one's is considered to be one data element in the above data lines. Hence every location on the barcode has different value against other location because the data element sequence is different at each location.

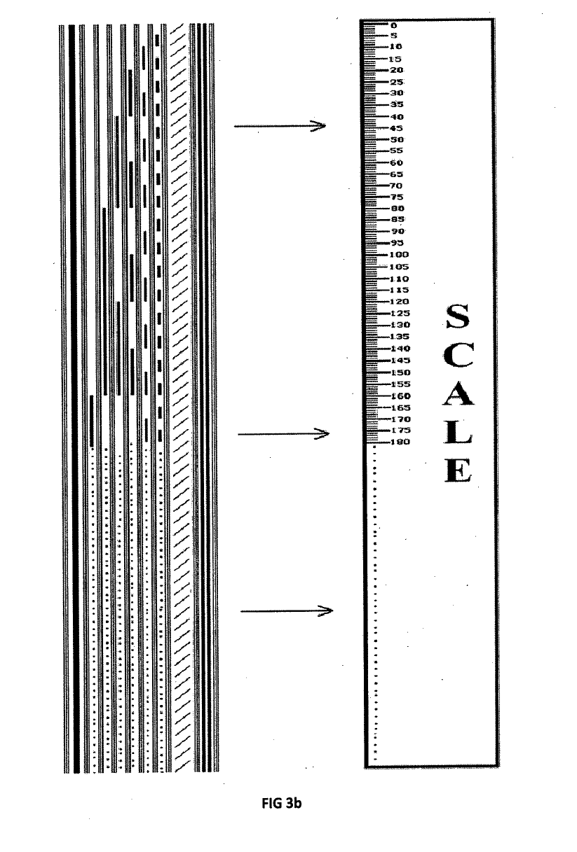

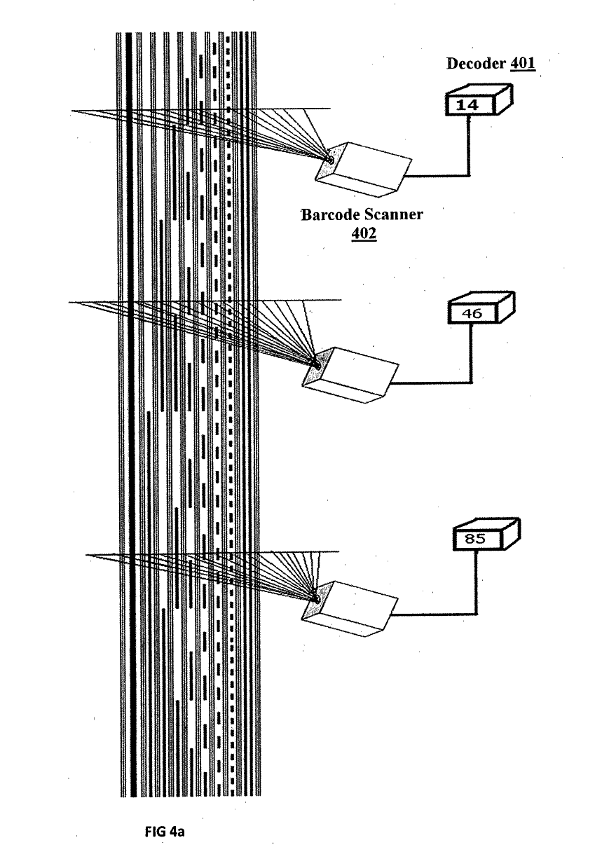

FIG. 3a and FIG. 3b represent relationship between barcode labels and Scale unit. FIG. 3A barcode format measures 100 divisions of Scale unit and FIG. 3b barcode format measurers more divisions in the same length of FIG. 3a because each sub data element 206 is associated with data element of last data line 203. Each subdata element 206 is able to measure five divisions of data element of last data line. It is also possible to measure more than five sub divisions depending on the capacity of barcode scanner 402.

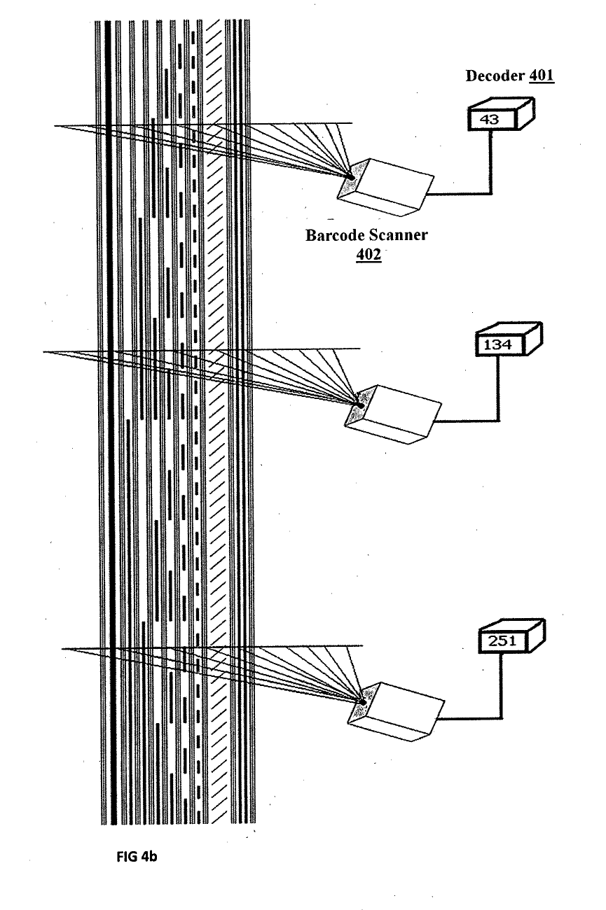

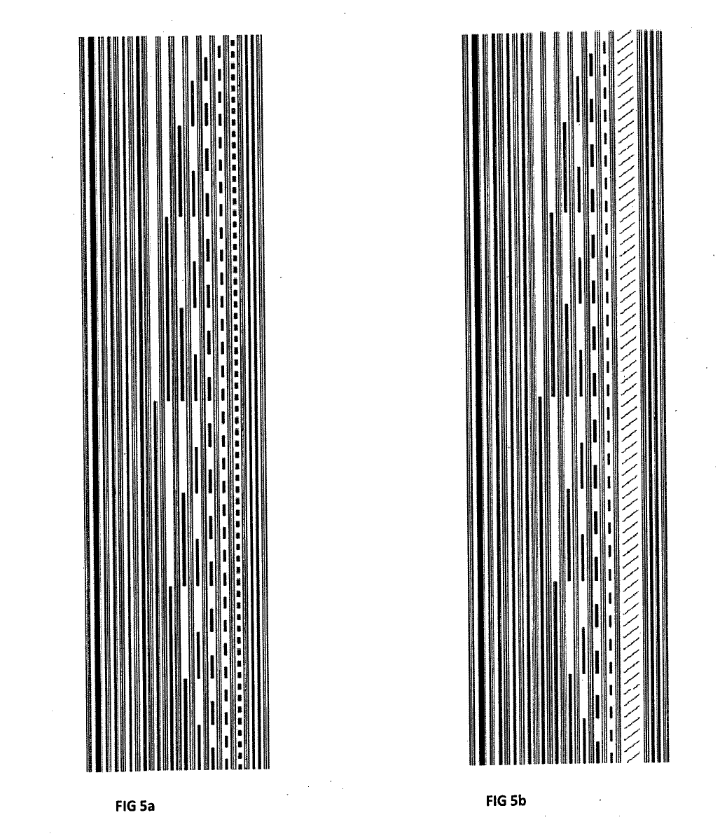

Various kinds of scanners may be used to read the Software printed barcode symbology. FIG. 4a and FIG. 4b shows how to read Software designed printed barcode. Software barcode reader which has a barcode scanner 402 and decoder 401 is depicted. The Scanner 402 scans the data on the barcode at different locations on the same barcode and decodes the corresponding values. For example Software Barcode reader scans at three different locations on a software barcode in FIG. 4a & FIG. 4b and displays the corresponding different values. In FIG. 4a, the Barcode reader displays 14, 46, 85 values and FIG. 4b display 43,134 and 251 values.

Table 1 summarizes encoding values for FIG. 3a and its corresponding decode values and Scale divisions.

| Scanner Location | Data Element | Decode value | Scale Division |
|---|---|---|---|
| 1 | 0000000 | 0 | 0 |
| 2 | 0000001 | 1 | 1 |
| 3 | 0000010 | 2 | 2 |
| 4 | 0000011 | 3 | 3 |
| . . . | . . . | . . . | . . . |
| . . . | . . . | . . . | . . . |
| . . . | . . . | . . . | . . . |
| 98 | 1000010 | 98 | 98 |
| 99 | 1000011 | 99 | 99 |
| 100 | 1000100 | 100 | 100 |
| . . . | . . . | . . . | . . . |
| . . . | . . . | . . . | . . . |

Table 2 summarizes encoding values for FIG. 3b and its corresponding decoder values and Scale divisions.

| Scanner | Data | Sub data | Decode | Scale |
|---|---|---|---|---|
| Location | Element | Element | value | Division |
| 1 | 000000 | 0 | 0.0 | 0 |
| 2 | 000000 | 1 | 0.1 | 1 |
| 3 | 000000 | 2 | 0.2 | 2 |
| 4 | 000000 | 3 | 0.3 | 3 |
| 5 | 000000 | 4 | 0.4 | 4 |
| 6 | 000001 | 0 | 1.0 | 5 |
| 7 | 000001 | 1 | 1.1 | 6 |
| 8 | 000001 | 2 | 1.2 | 7 |
| 9 | 000001 | 3 | 1.3 | 8 |
| 10 | 000001 | 4 | 1.4 | 9 |
| 11 | 000010 | 0 | 2.0 | 10 |
| 12 | 000010 | 1 | 2.1 | 11 |
| 13 | 000010 | 2 | 2.2 | 12 |
| 14 | 000010 | 3 | 2.3 | 13 |
| 15 | 000010 | 4 | 2.4 | 14 |
| . . . | . . . | . . . | . . . | . . . |
| . . . | . . . | . . . | . . . | . . . |
| 167 | 010010 | 0 | 34.0 | 166 |
| 168 | 010010 | 1 | 34.1 | 167 |
| 169 | 010010 | 2 | 34.2 | 168 |
| 170 | 010010 | 3 | 34.3 | 169 |
| 171 | 010010 | 4 | 34.4 | 170 |
| . . . | . . . | . . . | . . . | . . . |
| . . . | . . . | . . . | . . . | . . . |

A typical barcode data at particular instance is represented as

### BE+START Element+BE+DE+BE+DE+ . . . . . . +BE+DE+BE+SDE+BE+STOP Element+BE

### Where BE=Break Element,

### DE=Data Element,

### SDE=Sub Data Element

The actual data appears as below after removing break points.

DE.N+ . . . . . . DE.4+DE.3+DE.2+DE.1+DE.0+SDE (Sub Data Element)

Where 0, 1, 2, 3 . . . N are data lines

The barcode format as depicted in FIG. 1a contains seven data lines 203 and these seven data lines 203 displays 128 divisions (2**7). Thus the measurable distance using this barcode format is 128 divisions. FIG. 1b contains six data lines similar to FIG. 1a but the last data line 203 contains sub data element 206. FIG. 1b shows each sub data element 206 is divisible up to five divisions. Therefore the total measurable distance using with FIG. 1b barcode format is (2**6)*5=320 divisions. This division can be converted into general scale unit like Meter, Centimeter, Millimeter and so on.

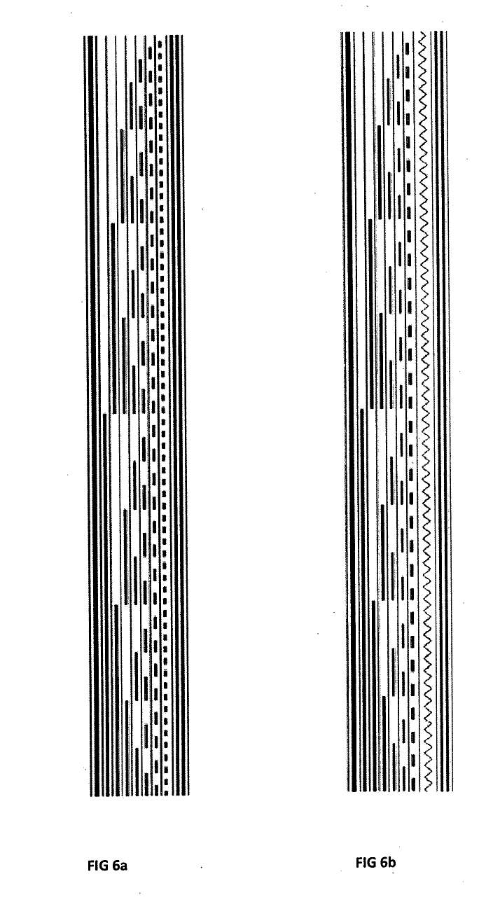

FIG. 5a barcode formats contain 10 data lines and FIG. 5b barcode format contains 9 data lines 203 along with one sub data line 206. Using FIG. 5a formats maximum measurable distance is 1024 (i.e. 2**10) divisions. FIG. 5b contains sub data element 206 which is divisible to another five divisions, therefore the maximum measurable distance using FIG. 5b is 2560 ((2**9)*5).

The barcode format also represent with simple break line which has single line. E.g FIG. 6a and FIG. 6b are barcode formats which contains only one line instead of three lines in the previous break line 202 barcode formats.

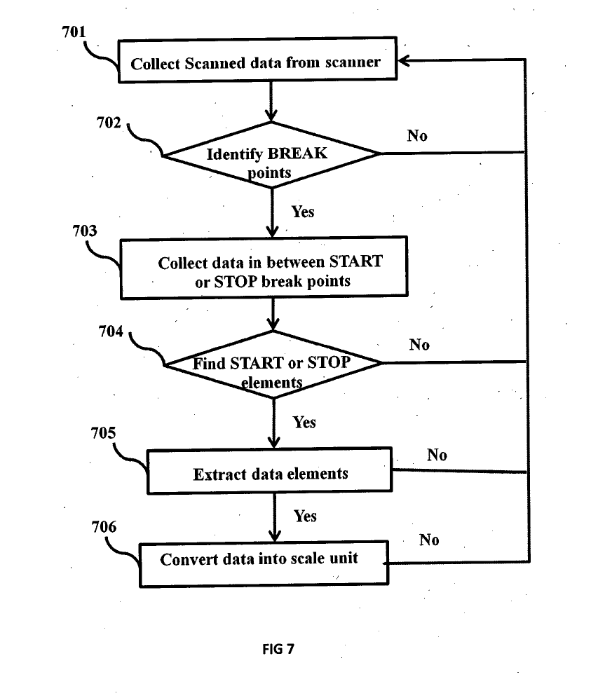

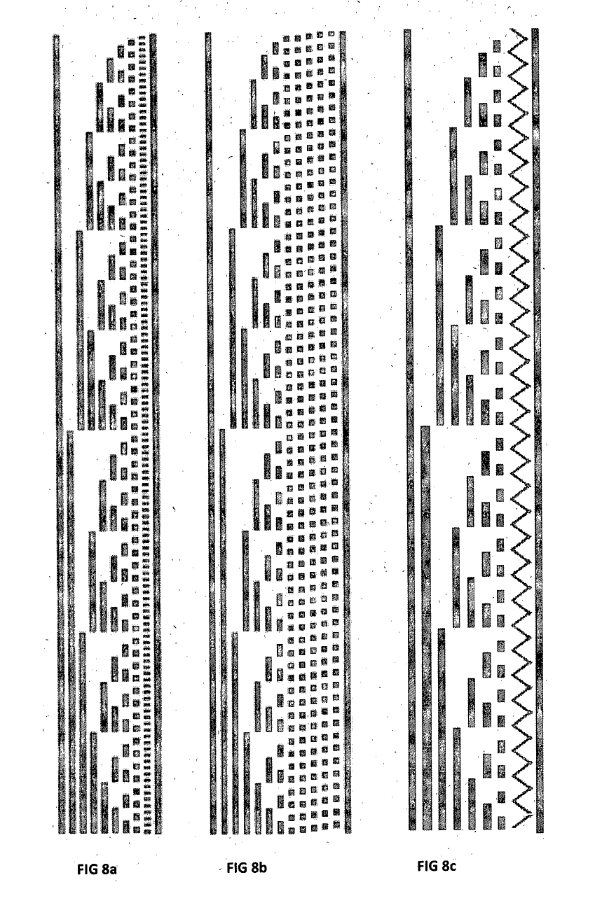

FIG. 7 is a flow chat illustrating the procedure for decoding Software Printed barcode data into Scale unit. First the scanner 402 scans on the barcode area and the data is collected (701) through the scanner or reader as shown in FIG. 4a and FIG. 4b. The break points are identified (702) on the scanned data collected which are very important to validate the data before going to next step. If the break points are not identified on the barcode, the barcode is scanned (701) again for the data. Once the break point is identified, data is collected (703) from the Start break point by removing lead data. Then the Start element is identified (704). If the Start element is not found it goes back to the first step (701) to iterate the above mentioned steps. Once it identifies the Start element, the data elements are extracted (705). The data elements are extracted until Stop break point is identified (704). Until the break point is identified data elements are being extracted. Once the Stop break point is identified, trail data is removed from the data elements. Start and Stop data elements are identified to validate data elements. After removing all break points from the data elements, it is converted into binary sequence. This binary sequence is then converted (706) into the scale unit. This procedure repeats itself at different points on the barcode to extract the data. The various actions in method 700 may be performed in the order presented, in a different order or simultaneously. Further, in some embodiments, some actions listed in FIG. 7 may be omitted.

Hardware designed barcodes comprise of black strip bars and white space bars. The black strip bars could be made of physical metal or any other appropriate stiff material through which electric signals can pass and the white space bars could be made of any stiff material which does not allow electric signals through it. In another embodiment herein, the white space bars may be blank spaces. Hardware designed barcode symbology could be represented in various ways. FIG. 8a, FIG. 8b & FIG. 8c are various formats of Hardware designed barcode symbology. e.g. FIG. 8a is simple barcode format; FIG. 8b contains four extra lines along with other lines of FIG. 8a. FIG. 8c contains small cross lines in additions to FIG. 8a format.

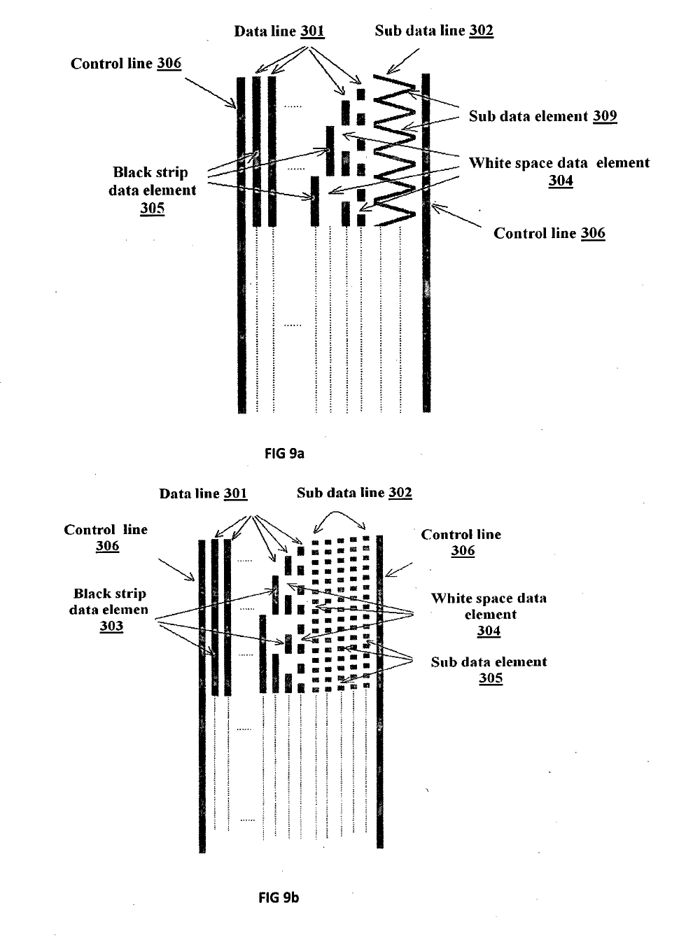

The structural representation of the hardware designed barcode symbology is show in FIG. 9a and FIG. 9b. The new symbology compromises of the following elements.

Data Line 301—Data lines 301 are straight lines which are compromises of sequence of Black strips and White spaces. All black strips and white spaces are in equal size.
Sub Data Line 302—Sub data line 302 is also a data line using more divisions can measure. Sub data line 302 can be present in different ways, one is with cross lines in ‘>’ shape format. Another option is clone last data line and then position all cloned data lines with little measurable difference in the start location of data line. Both formats are show in the FIG. 8b and FIG. 8c.
Data Elements—Data elements are classified into to two types; i.e., Black Strip Data element 303 and White Space Data element 304. Black strip data element 303 pass electric signals where as White space data elements 304 can't pass electric signals through. At any point of time only one data element is countable in one Data Line. All data elements are in equal size in a data line where as data elements are double in size when compare in two subsequent data lines.
Sub Data Element 305—Sub data elements 305 are specially designed data element using which data element of least size is further divisible into subdivisions. Sub data elements are very important component in the hardware barcode frame to measure more divisions of data element of last data line. Sub data elements 305 are associated with data elements of the last data line 301. Data line 301 which has data element with least size is considered to be last data line in the barcode frame.
Control Line 306—Control line 306 is straight black line which pass electric signal to the barcode design frame from external source. First Line and the Last line represented in the FIG. 9a are control lines 306 where electric signals pass to the hardware barcode frame. A Barcode code frame can have one or two control lines 306.

As described in the Software Designed Barcode symbology, all data lines 301 in the hardware barcode symbology are framed in binary sequence; i.e., first data line 301 comprises of two data elements with one Black Strip data element 303 and one White Space data element 304. Second data line contains four data elements of which two are Black strip and two are White space data elements and are arranged in BWBW order; i.e., BlackWhiteBlackWhite. These four data elements are equal in size and the total size of all these four data elements are equal to the size of two data elements of first data line. Each data line 301 is dependent on the previous data line 301 starting with two data elements in the first data line. Below is a binary sequence format of data lines in which ‘0’ represents Black Strip and ‘1’ represents White Space.

### Data Line 1—0000000000000000 . . . . . . . . . 1111111111111111 . . . . . .

### Data Line 2—000000011111111 . . . . . . . . . . 0000000011111111 . . . . . .

### Data Line 3—0000111100001111 . . . . . . . . . 0000111100001111 . . . . . .

### Data Line 4—0011001100110011 . . . . . . . . . 0011001100110011 . . . . . .

. . . . . . . . . . . . . . . . . . . . . . . . . . . . .
. . . . . . . . . . . . . . . . . . . . . . . . . . . . .

### Data Line N—01010101010101010101010101010101010101 . . . . . .

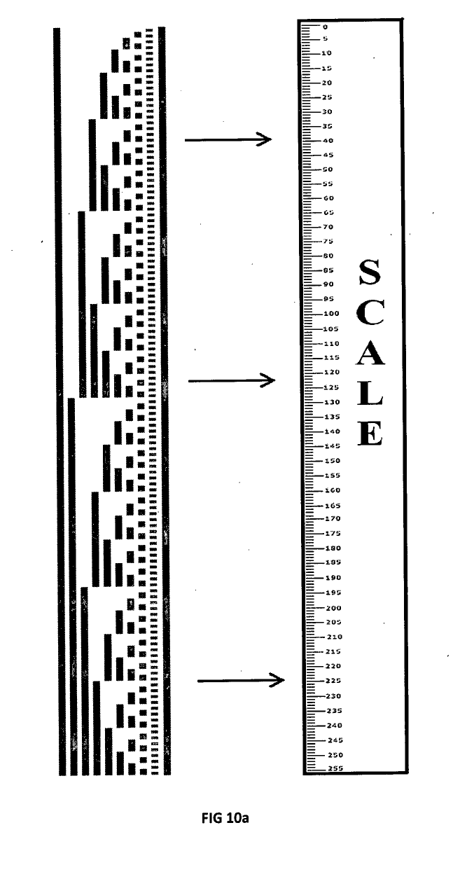

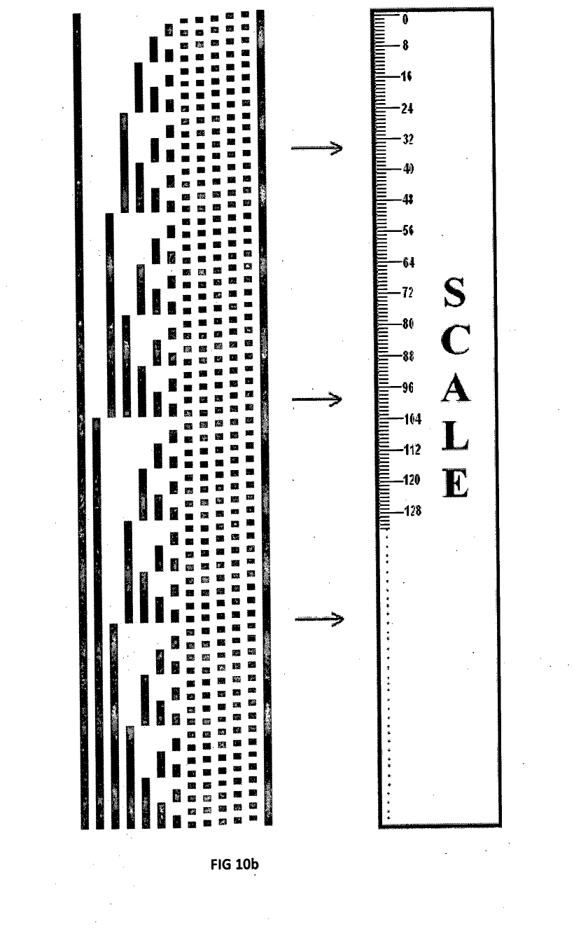

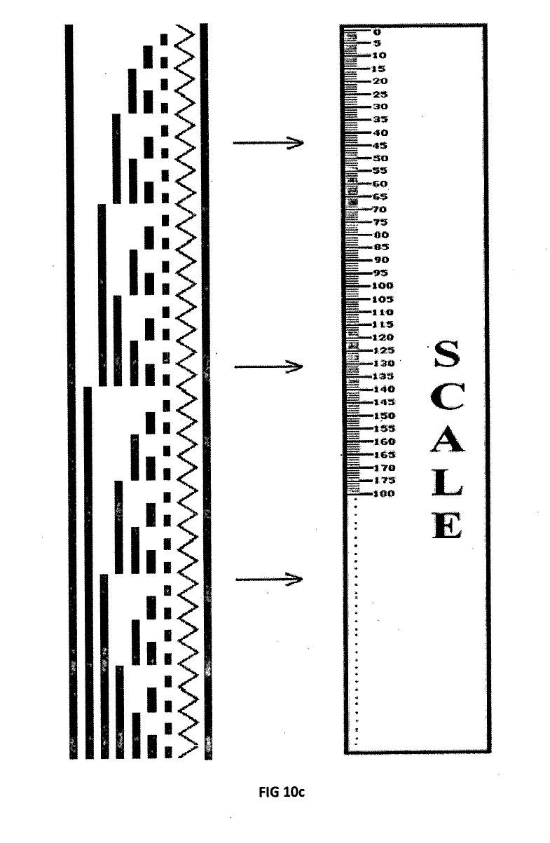

The above format is typical binary sequence of the barcode structure in which continuous sequence of zero's OR one's is considered as one data element in each data line 301. All data lines are framed such that at any point of time data elements of all data lines gives the binary number format as represented above, which are then further converted into scale units. FIG. 10a, FIG. 10b & FIG. 10c shows pictorial representation of Hardware Barcode Format with corresponding scale unit. FIG. 10b & FIG. 10c reads more subdivisions than FIG. 10a because sub data line elements 305 are added in addition to the other data lines, each sub data element 306 is divisible of up to 8 divisions in FIG. 10b and each sub data element 306 is divisible of up to 5 divisions in FIG. 10c.

As described in the Software printed barcode, similarly at any point of time only one data element is countable from each data line in the hardware barcode design, below is general format of sequence of data elements of consolidating all data lines.

DE 1+DE 2+DE 3+DE 4+ . . . . . . +DE N+SDE1+SDE2+ . . . SDEN

### Where DE—Data Element

### SDE—Sub Data Element

1, 2, 3 . . . N Data lines or Sub Data lines

FIG. 10a contains 8 data lines using which 256 (2**8) divisions can measure where as FIG. 10b contains 7 data lines and four sub data lines which can measure least data line into further 8 sub divisions, so total measurable units using with FIG. 10b format are 512 i.e. ((2**6)*8). FIG. 10c also contains subdata elements which can again divisible up to 5 sub divisions, so total measurable units using with FIG. 10c format are 320 i.e. ((2**6)*5).

Table 3 summarization of encoding values for FIG. 10a and its corresponding decode values and Scale divisions.

| Scanner Location | Data Element | Decode value | Scale Division |
|---|---|---|---|
| 1 | 0000000 | 0 | 0 |
| 2 | 0000001 | 1 | 1 |
| 3 | 0000010 | 2 | 2 |
| 4 | 0000011 | 3 | 3 |
| . . . | . . . | . . . | . . . |
| . . . | . . . | . . . | . . . |
| . . . | . . . | . . . | . . . |
| 98 | 1000010 | 98 | 98 |
| 99 | 1000011 | 99 | 99 |
| 100 | 1000100 | 100 | 100 |
| . . . | . . . | . . . | . . . |

Table 4 summarizes encoding values for FIG. 10b and its corresponding decodes values and Scale divisions.

| Scanner | Data | Sub data | Decode | Scale |
|---|---|---|---|---|
| Location | Element | Element | value | Division |
| 1 | 000000 | 0 | 0.0 | 0 |
| 2 | 000000 | 1 | 0.1 | 1 |
| 3 | 000000 | 2 | 0.2 | 2 |
| 4 | 000000 | 3 | 0.3 | 3 |
| 5 | 000000 | 4 | 0.4 | 4 |
| 6 | 000000 | 5 | 0.5 | 5 |
| 7 | 000000 | 6 | 0.6 | 6 |
| 8 | 000000 | 7 | 0.7 | 7 |
| 9 | 000001 | 3 | 1.0 | 8 |
| 10 | 000001 | 4 | 1.1 | 9 |
| 11 | 000010 | 0 | 1.2 | 10 |
| 12 | 000010 | 1 | 1.3 | 11 |
| 13 | 000010 | 2 | 1.4 | 12 |
| 14 | 000010 | 3 | 1.5 | 13 |
| 15 | 000010 | 4 | 1.6 | 14 |
| . . . | . . . | . . . | . . . | . . . |
| . . . | . . . | . . . | . . . | . . . |
| 167 | 010010 | 0 | 34.0 | 166 |
| 168 | 010010 | 1 | 34.1 | 167 |
| 169 | 010010 | 2 | 34.2 | 168 |
| 170 | 010010 | 3 | 34.3 | 169 |
| 171 | 010010 | 4 | 34.4 | 170 |
| 168 | 010010 | 5 | 34.5 | 171 |
| 169 | 010010 | 6 | 34.6 | 172 |
| 170 | 010010 | 7 | 34.7 | 173 |
| . . . | . . . | . . . | . . . | . . . |
| . . . | . . . | . . . | . . . | . . . |

Table 5 summarizes encoding values for FIG. 10c and its corresponding decodes values and Scale divisions.

| Scanner | Data | Sub data | Decode | Scale |
|---|---|---|---|---|
| Location | Element | Element | value | Division |
| 1 | 000000 | 0 | 0.0 | 0 |
| 2 | 000000 | 1 | 0.1 | 1 |
| 3 | 000000 | 2 | 0.2 | 2 |
| 4 | 000000 | 3 | 0.3 | 3 |
| 5 | 000000 | 4 | 0.4 | 4 |
| 6 | 000001 | 0 | 1.0 | 5 |
| 7 | 000001 | 1 | 1.1 | 6 |
| 8 | 000001 | 2 | 1.2 | 7 |
| 9 | 000001 | 3 | 1.3 | 8 |
| 10 | 000001 | 4 | 1.4 | 9 |
| 11 | 000010 | 0 | 2.0 | 10 |
| 12 | 000010 | 1 | 2.1 | 11 |
| 13 | 000010 | 2 | 2.2 | 12 |
| 14 | 000010 | 3 | 2.3 | 13 |
| 15 | 000010 | 4 | 2.4 | 14 |
| . . . | . . . | . . . | . . . | . . . |
| . . . | . . . | . . . | . . . | . . . |
| 167 | 010010 | 0 | 34.0 | 166 |
| 168 | 010010 | 1 | 34.1 | 167 |
| 169 | 010010 | 2 | 34.2 | 168 |
| 170 | 010010 | 3 | 34.3 | 169 |
| 171 | 010010 | 4 | 34.4 | 170 |

A Slider header is a new device which rolls freely over the surface of the hardware barcode frame. The slider header consists of slider pins where slider pins are mapped to data lines of the hardware barcode frame. As and when the slider header moves on the surfaces of the barcode frame, all slider pins touches on the data lines of the barcode and passes signals to decoder unit to convert signals into numeric scale unit.

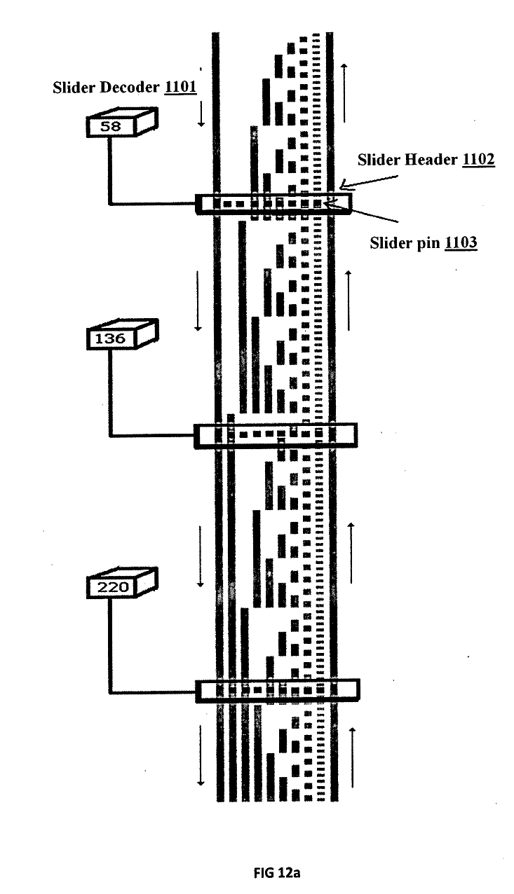

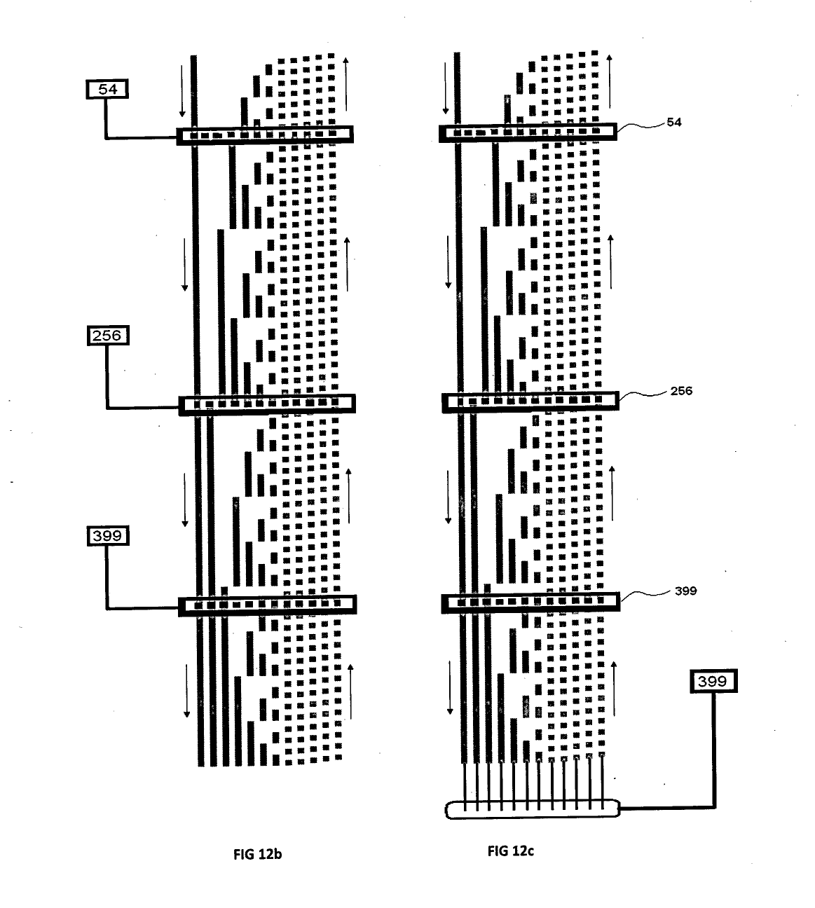

FIG. 12a, FIG. 12b and FIG. 12c illustrate the Slider Header rolling on the barcode frame at various locations. In FIG. 12a, various positions read in the barcode frame are 58, 136 and 220. In FIG. 12b & FIG. 12c various positions read are 54, 256 and 399. The difference between FIG. 12b and FIG. 12c are—in FIG. 12b Slider Pins are connected to the slider decoder where as in FIG. 12c Barcode data lines are directly connected to the Decoder device, in this case Slider pins act as a controller to pass electric signals to data lines.

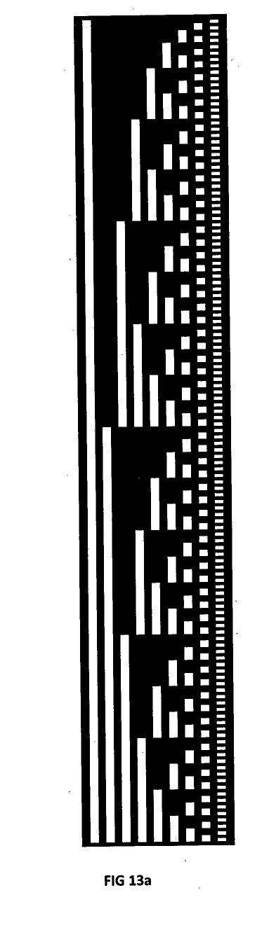

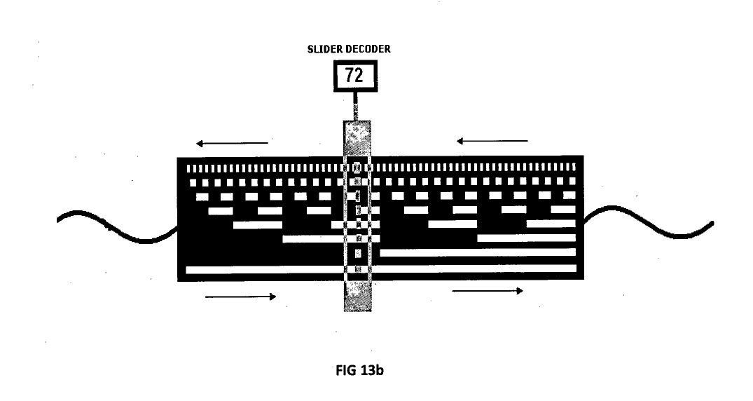

The Hardware barcode frame can be designed in another format which is show in FIG. 13a. In this design, all the black space region is made-up of material which doesn't allow electric signals through it and all the white space regions is subtracted from the material so that the complete frame appears in the new hardware barcode frame.

The Slider Header also designed suitable to read the new hardware barcode structure which is framed in thin sheet as described in the above section. The slider header is designed such that the above hardware barcode frame moves freely inside the slider header which is shown in FIG. 13b. All Slider pins touch on the surfaces of the Hardware barcode device. The Slider pins don't transfer electric signals while touching on the black surface region. Slider pins touches on the other side of the Slider header while moving on the white space region because of white space region is empty, the slider pins transfer electric signals whenever it touches on the other side of the slider header. Hence all slider pins transfer electric signals dynamically while the new hardware barcode frame moves inside the slider header device.

The main difference between the Hardware designed barcode frame and the Software designed barcode is—barcode reader scans the new software printed barcodes where as the Slider Barcode Reader specially designed device is used to read signals from the data lines of the Hardware Designed barcodes or the slider pins of the slider header.

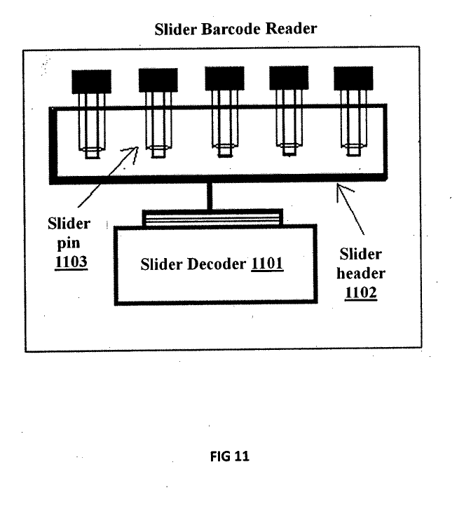

Another embodiment is Slider Barcode Reader, also called as Barcode Reader, equipment especially designed to read hardware designed barcodes. The FIG. 11 illustrates block diagram of the barcode reader. The Barcode Reader is a device which comprises of Slider Header 1102, Slider Pins 1103 and Decoder 1101. The Decoder is a pluggable device, the Slider Header & the Slider pins are associated as one unit in the Slider Reader.

Slider Header 1102 is made of a suitable stiff material which can freely move on the surface of Hardware Designed Barcode frame. All Slider Pins 1103 are attached to this Header 1102 device so that all connected pins also move along with the Header device 1102. The header device 1102 can move with different options. One option is, using a stiff rope wire connect tightly to the header device and then move up & down with wire, as and when pulls the wire up and down the header device also moves freely along with the wire. Another option is, a square or rectangular shape device (which is empty inside or filled with air) tied with the header device. The header 1102 device floats on water or any liquid material because header device is attached with other device which floats on water or any liquid. This approach will help to measure liquid level of a tank using the barcode device.

Slider Pin 1103 is a small thin device made of metal or any device which can pass electric signals. Each slider pin touches to one'data line 301 of the hardware barcode frame and pass signals to the decoder through the slider header 1102. The Slider pins 1103 are pluggable and can add as many as required based on number of data lines 301 used in the hardware barcode frame. All slider pins are in straight line perpendicular to barcode data lines 301. All slider pins 1103 moves along with the slider header 1102 as and when the slider header 1102 moves on top of barcode frame, all slider pins pass signals to the decoder dynamically while moving over the hardware barcode frame.

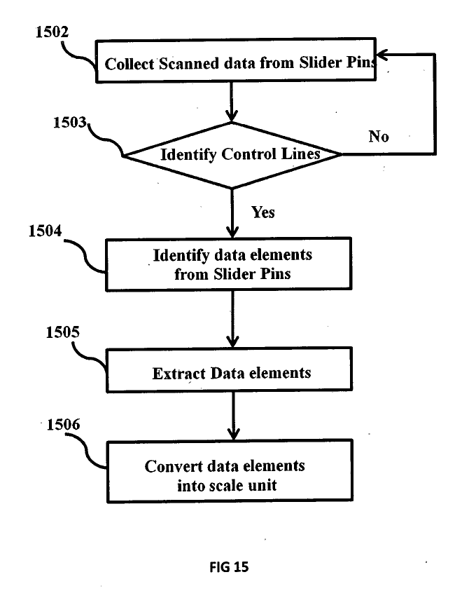

Decoder 1101 is especially designed to receive electric signals and convert sequence of signals into binary sequence which again convert into numeric format. The numeric format is then converted into scale units. The Decoder 1101 receives electric signals either from slider pins or from hardware barcode data lines. The Decoder 1101 can be tied along with the Slider Header device 1102 or can be separated from it. Flow chart described in FIG. 15 explains detailed decoder flow starting from receiving signals to display scale unit value.

The decoder is also designed such that the decoder identifies and differentiates high & low electric signals which receive from the black strip data element and the white space data element in the barcode structure where the black strip data element is made up of good electric condense material and the white space data element made up of poor electric condense material. As and when the slider header moves on the barcode structure, the decoder receives high and low electric signals dynamically from the slider pins or the data lines, and then decoder convert signals into numeric scale unit.

FIG. 12a, FIG. 12b & FIG. 12c are pictorial representation of the Slider header 1101 rolling on the barcode frame. In FIG. 12a, slider header reads data at multiple locations and displays values 58, 120 and 224 in the corresponding locations. In FIG. 12b & FIG. 12c, the slider header reads data and displays values 54, 256 and 399 in the corresponding locations. In FIG. 12b & FIG. 12c, the subdatalines are framed in the hardware barcode structure and hence more number of divisions can measure compare with FIG. 12a.

The Slider Header 1102 device is designed in another format suitable to read thin sheet hardware frame. The slider header 1102 is designed such that thin sheet hardware barcode frame moves freely inside the slider header which is shown in FIG. 13b. All Slider pins 1103 touch on the surfaces of thin sheet Hardware barcode frame and slider pins touch on the other side of the slider header in the white space region of thin sheet device. The slider pins 1103 do not pass electric signals when touching on the surface of thin sheet, but slider pins 1103 pass electric signals when touching to the other side of the slider header 1102 while moving over white space region of the thin sheet device. As and when thin sheet hardware barcode device moves inside the Slider Header device 1102, slider pins 1103 passes electric signals dynamically to the decoder 1102 and then the decoder 1102 convert signals into binary format.

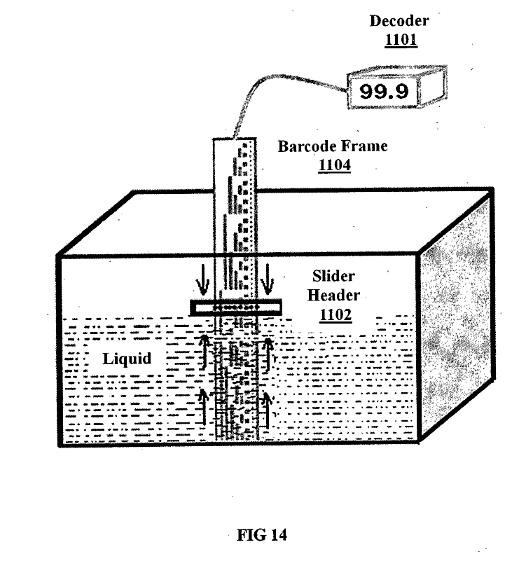

FIG. 14 illustrates measuring liquid level of a tank using the barcode frame. The slide header 1102 floats on the surface of liquid when the barcode frame place in a liquid tank. The slider header 1102 moves upwards when liquid level increases and goes down when liquid level decreases. The decoder device receives signals from the slider pins 1103 or data lines 301 as and when the slider header moves up/down and then converts signals into numerical scale unit and then measure liquid level in the tank by considering the tank measurements.

FIG. 15 illustrates a flow diagram which shows steps involved in the process of decoding hardware printed barcode symbology as disclosed in the embodiments herein. The hardware barcode decoding mechanism comprises a plurality of slider pins 1103 associated with a slider header 1102. The slider pins 1103 slide over the hardware barcode lines. In one embodiment, each slider pin 1103 slides over separate data lines in the hardware barcode. While sliding over the data lines 203, the slider pins 1103 collect (1502) electrical signals corresponding to the data lines 203 and send the collected data to a decoder unit 1101. In one embodiment, the data line 203 may have different value at different points on the same line. Further, for the received data, the decoder unit 1101 identifies (1503) control lines. After identifying the control lines, the decoder unit 1101 identifies (1504) data elements present in the received data. The data elements 203 are further extracted (1505) and are converted to corresponding binary value. This binary sequences are further converted (1506) into a corresponding scale unit. In one embodiment, the scale unit thus obtained may correspond to the length of a material or the distance between materials to which the barcode is referenced. The various actions in method 1400 may be performed in the order presented, in a different order or simultaneously. Further, in some embodiments, some actions listed in FIG. 15 may be omitted.

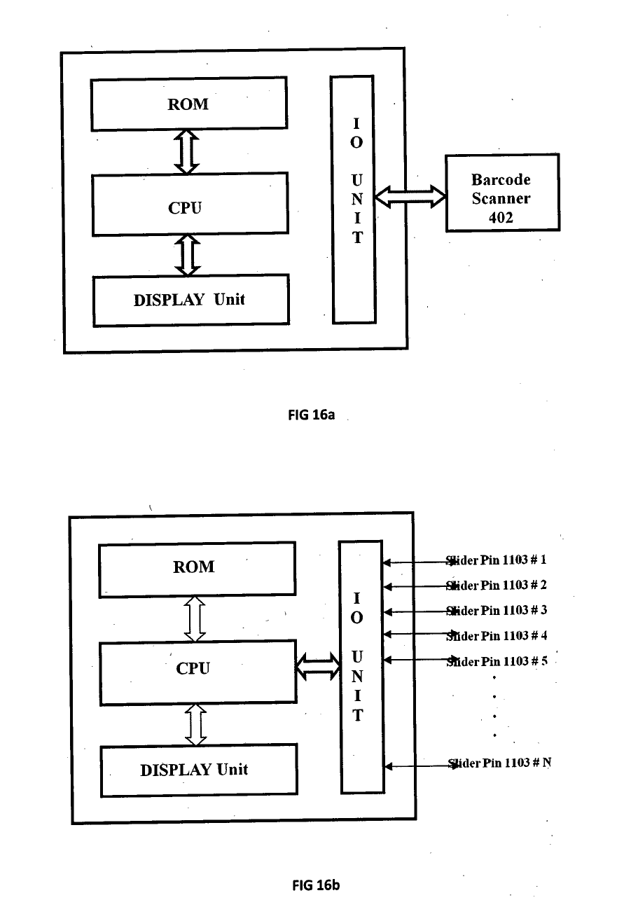

Decoding is a process of receiving data from the Slider pins 1103 or the Data lines 301 (the hardware designed barcodes) OR from Barcode scanner (the software printed barcodes) and then converting the data into numeric scale units. FIG. 16a illustrate block diagram to decode the Software Printed Barcodes and FIG. 16b illustrate block diagram to decode the Hardware Designed Barcodes. Decoder unit compromises of ROM, CPU, Display Unit and IO Unit. ROM is read only memory device which contains decoding program to decode the data. CPU is processor unit which controls all other devices, loads program from ROM and executes the program, sends and receives data from IO Unit from external interface. In FIG. 16a, IO Unit connects to Barcode Scanner to receive undecoded data of the Software Printed barcodes. In FIG. 16b, IO Unit connects to the Slider Pins or the data lines to receive signals from the Hardware Barcodes.

FIG. 16a and FIG. 16b illustrates block diagrams of the proposed software barcode reading system and hardware barcode reading system respectively, as disclosed in the embodiments herein. The software based length measurement system comprises a software barcode decoding unit 401, channel and a barcode scanner 402. The barcode scanner 402 scans the software barcodes attached to the material to which the barcode is referenced. Further, the scanned data is sent to a decoder unit 401 through a channel. The channel may be a wireless channel or a wired channel. Further, the decoder unit 401 processes the data received from the barcode scanner 402. In one embodiment, the data processing may comprise converting the received data into a scale unit in digital form. Further, from the processed data, the system may measure/calculate the length of the material or the distance between materials.

The hardware based length measurement system as in FIG. 16b comprises hardware barcode decoding unit (slider decoder) 1101, channel 102 and slider pins 1103. Each of the slider pins 1103 touches separate lines and passes the information signals to the decoder unit 1101. In one, embodiment, the slider pins 1103 are pluggable and the number of slider pins 1103 may be varied according to requirement. Further, the hardware barcode decoding unit 1101 processes the signals received from the slider pins 1103 during which the received data may be converted to scale unit in digital format. In one embodiment, the hardware barcode decoding unit 1101 may be a special decoder circuit that is capable of receiving and processing signals in the form of electrical signals. Further, from the processed information, the system measures the length of the material or the distance between two materials. The data transfer between the decoding unit 1101 and the slider pins 1103 may take place through a channel. Further, the channel may be a wired channel or a wireless channel.

The embodiments disclosed herein can be implemented through at least one software program running on at least one hardware device and performing network management functions to control the network elements formed by the embodiments disclosed in the invention.

The embodiment disclosed herein describes Software printed barcode symbology, Hardware Designed barcode symbology and a Slider Barcode Reader and decoder to read the software and hardware printed barcode symbology. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in a preferred embodiment through or together with a software program written in e.g. Very high speed integrated circuit Hardware Description Language (VHDL) another programming language, or implemented by one or more VHDL or several software modules being executed on at least one hardware device. The hardware device can be any kind of portable device that can be programmed. The device may also include means which could be e.g. hardware means like e.g. an ASIC, or a combination of hardware and software means, e.g. an ASIC and an FPGA, or at least one microprocessor and at least one memory with software modules located therein. The method embodiments described herein could be implemented partly in hardware and partly in software. Alternatively, the invention may be implemented on different hardware devices, e.g. using a plurality of CPUs.

The foregoing description of the specific embodiments will so fully reveal the general nature of the embodiments herein that others can, by applying current knowledge, readily, modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

We claim:

1. A bar code structure comprising of a plurality of rows of bar coded information, wherein bar coded information in each of said plurality of rows comprises of an array of binary sequences, wherein each of said binary sequences represents a scale unit, further each of said plurality of rows comprising of a sequence of black bars and white spaces.

2. The barcode structure, as claimed in claim 1, wherein said barcode structure is representation of numeric scale format with variable length.

3. The barcode structure, as claimed in claim 1, wherein said barcode structure is represented by a software printed barcode structure, wherein said software printed barcode structure comprises of
At least one unbroken black lines; and
At least one black line interleaved with white spaces.

4. The barcode structure, as claimed in claim 3, wherein said software printed barcode structure comprises of a plurality of data lines, wherein each of said plurality of data lines builds on at least one previous data line.

5. The barcode structure, as claimed in claim 4, wherein first data line from said plurality of data lines represents a start data line.

6. The barcode structure, as claimed in claim 4, wherein last data line from said plurality of data lines represents a stop data line.

7. The barcode structure, as claimed in claim 4, wherein each of said plurality of data lines comprise of a plurality of data elements, wherein each of said plurality of data elements are equal in size and size of plurality of data elements in each of said data line is double in size of data elements in previous data line.

8. The barcode structure, as claimed in claim 7, wherein each of said plurality of data elements comprises of
At least one black strip data element; and
At least one white space data element,
Wherein said data elements in the barcode structure in plurality represents a unique sequence binary format at any position within said barcode structure.

9. The barcode structure, as claimed in claim 3, wherein said software printed barcode structure comprises at least one break line, wherein each of said data line is associated with two said break lines.

10. The barcode structure, as claimed in claim 3, wherein said software printed barcode structure sequence comprise of a sub data line, wherein said sub data line comprises of a plurality of sub data elements, wherein said plurality of data elements are represented by slanted black lines.

11. The barcode structure, as claimed in claim 10, wherein said sub data line is associated with last data line.

12. The barcode structure, as claimed in claim 3, wherein said software printed barcode structure is scanned by a scanner.

13. The barcode structure, as claimed in claim 12, wherein said scanner reads only one data element in each of said plurality of data lines at any point of time.

14. The barcode structure, as claimed in claim 1, wherein said barcode structure is represented by a Hardware barcode structure, wherein said hardware barcode structure comprises of
At least one unbroken black lines; and
At least one black line interleaved with white spaces.

15. The barcode structure, as claimed in claim 14, wherein said black strip lines are made up of stiff material, wherein said stiff material is a good conductor of electricity.

16. The barcode structure, as claimed in claim 14, wherein said white spaces are made of material, wherein said material is a bad conductor of electricity.

17. The barcode structure, as claimed in claim 14, wherein said white spaces are made of material, wherein said material is poor conductor of electricity.

18. The barcode structure, as claimed in claim 17, wherein receiver or decoder differentiates and recognizes signals received with high and low electric signals from said black strip lines and said white spaces lines respectively.

19. The barcode structure, as claimed in claim 14, wherein said hardware barcode structure comprises of a plurality of data lines, wherein each of said plurality of data lines builds on at least one previous data line.

20. The barcode structure, as claimed in claim 19, wherein each of said plurality of data lines comprise of a plurality of data elements, wherein each of said plurality of data elements are equal in size and size of plurality of data elements in each of said data line is double in size of data elements in previous data line.

21. The barcode structure of claim 19, wherein smallest size data element of a data line is a sub data line, further multiple said sub data lines can be added to the barcode structure to measure more sub divisions of said data element of last data line.

22. The barcode structure, as claimed in claim 14, wherein each of said plurality of data elements in each of said plurality of data line is electrically connected internally.

23. The barcode structure, as claimed in claim 14, wherein the barcode structure comprises of a plurality of control lines, wherein said plurality of control lines receive electric signals from external source and supply electric signals to said plurality of data lines.

24. A method of decoding a barcode structure, wherein said barcode structure comprises a plurality of ordered rows of barcode information, further each of said plurality of rows contains a plurality of data elements, a plurality of sub data elements, a plurality of break lines, at least one start element and at least one stop data element, said method compromising of
Scanning said barcode structure at any location within said barcode structure;
Identifying said plurality of break lines from said scanned data;
Removing lead & trail data based on said identified break lines;
Extracting data elements from said scanned data;
Converting said extracted data elements into binary format; and
Converting said binary format into a numeric scale unit.

25. The method, as claimed in claim 24, wherein said method further comprises of removing all break points present in between said extracted data elements.

26. The method, as claimed in claim 24, wherein said method further comprises of identifying first and last data elements from said extracted data elements.

27. A decoder for decoding a barcode structure, wherein said barcode structure comprises a plurality of ordered rows of barcode information, further each of said plurality of rows contains a plurality of data elements, a plurality of sub data elements, a plurality of break lines, at least one start element and at least one stop data element, said decoder comprising at least one means configured for
Receiving scanned data from a scanner, wherein said scanned data is from said scanner scanning said barcode structure at any location within said barcode structure;
Identifying said plurality of break lines from said scanned data;
Removing lead & trail data based on said identified break lines;
Extracting data elements from said scanned data;
Converting said extracted data elements into binary format; and
Converting said binary format into a numeric scale unit.

28. The decoder, as claimed in claim 27, wherein said decoder is further configured for removing all break points present in between said extracted data elements.

29. The decoder, as claimed in claim 27, wherein said decoder is further configured for identifying first and last data elements from said extracted data elements.

30. A method of decoding a barcode structure, wherein said barcode structure comprises a plurality of ordered rows of barcode information, said method compromising of
Moving a barcode reader on said barcode structure, wherein slider pins on said barcode reader are in contact with data lines on said barcode structure and electric signals are passing through said data lines;
Collecting said signals dynamically from said data lines;
Converting said collected signals into a binary sequence; and
Converting said binary sequence into a scale unit.

31. The method, as claimed in claim 30, wherein said method further comprises of
Sending said electric signals to a control line in said barcode structure;
Transferring said electric signals from said control line to all data lines; and
Verifying that said data lines transfer said electrical signals correctly.

32. The method, as claimed in claim 30, wherein said signals are collected through said slider pins.

33. The method, as claimed in claim 30, wherein said signals are directly from said data lines.

34. A Barcode reader for decoding a barcode structure, wherein said barcode structure comprises a plurality of ordered rows of barcode information, said barcode comprising at least one means configured for
Moving on said barcode structure, wherein a plurality of slider pins on said barcode reader are in contact with data lines on said barcode structure and electric signals are passing through said data lines;
Collecting said signals dynamically from said data lines;
Converting said collected signals into a binary sequence; and
Converting said binary sequence into a scale unit.

35. The barcode reader, as claimed in claim 34, wherein said barcode reader further comprises at least one means configured for
Sending said electric signals to a control line in said barcode structure;
Transferring said electric signals from said control line to all data lines; and
Verifying that said data lines transfer said electrical signals correctly.

36. The barcode reader, as claimed in claim 34, wherein said barcode reader is configured for collecting said signals through said slider pins.

37. The barcode reader, as claimed in claim 34, wherein said barcode reader is configured for collecting said signals directly from said data lines.

38. The Barcode reader, as claimed in claim 34 wherein said barcode reader comprises of
A Slider header, And
A Barcode decoder.

39. The Barcode reader, as claimed in claim 38, wherein said Barcode decoder is plugged into said barcode reader.

40. The barcode reader, as claimed in claim 38, wherein said Slider header rolls freely on the surface of said barcode structure.

41. The barcode reader, as claimed in claim 34, wherein said plurality of slider pins are made of good conductors of electricity.

42. The barcode reader, as claimed in claim 34, wherein each of said plurality of slider pins are mapped to one data line in said barcode structure.

43. The barcode reader, as claimed in claim 38, wherein each of said plurality of slider pins are fixed to said slider header, such that said slider pins move along with said slider header freely.

44. The Barcode Decoder, as claimed in claim 34, wherein said barcode decoder is configured for providing connections through IO channels of said decoder, such that said decoder directly receives signals from at least one of
said plurality of slider pins; or
said plurality of data lines.

45. The barcode reader, as claimed in claim 38, wherein said slider header is designed in such that said barcode structure can move freely inside the barcode header.
